(19) United States
(12) Patent Application Publication
(10) Pub. No.: US 2011/0036682 A1
(43) Pub. Date: Feb. 17, 2011

(54) BILL PROCESSING DEVICE, REGISTER DEVICE, CHANGE MACHINE, DISTRIBUTION DEVICE, AND NETWORK SYSTEM

(75) Inventor: Takeshi Koyano, Tokyo (JP)

Correspondence Address: RABIN & Berdo, PC, 1101 14TH STREET, NW, SUITE 500, WASHINGTON, DC, 20005, US

(73) Assignee: Oki Electric Industry Co., Ltd., Tokyo (JP)

(21) Appl. No.: 12/736,620

(22) PCT Filed: Jan. 9, 2009
(86) PCT No.: PCT/JP2009/050206

§ 371 Date: Oct. 22, 2010

(30) Foreign Application Priority Data
Apr. 23, 2008 (JP) 2008-112979

(51) Int. Cl. G07D 7/00; G07F 7/04; G07G 1/00

(52) U.S. Cl. 194/206; 194/302; 382/135

(57) ABSTRACT

In a bill processing device, a fake bill profile information acquiring unit acquires, from an external distribution device, fake bill profile information that is used in discriminating fake bills, and a fake bill profile information registration unit registers acquired information, and a bill discriminating unit discriminates, on the basis of the information, whether or not a deposited bill is a fake bill, and a fake bill processing unit does not accept a deposited bill that is discriminated to be a fake bill.

### TECHNICAL FIELD

The present invention relates to a bill processing device, a register device, a change machine, a distribution device, and a network system, and can be applied to, for example, a POS (Point of Sales) system.

### BACKGROUND ART

At the register checkout in a store such as a supermarket, a convenience store, a discount shop, a gas station, or the like, a bill change machine is mounted to the register machine (the register device) such as a POS register or the like in order to manage the reserve change that is needed for cash sales. As a bill processing device (a cash deposit/dispensing processing device) that is installed as a bill change machine in a register machine or the like, there are the devices recited in Japanese Patent Application Laid-Open No. 2005-293540 (Patent Document 1), Japanese Patent Application Laid-Open No. 2007-34523 (Patent Document 2).

The devices recited in Japanese Patent Application Laid-Open No. 2005-293540 and Japanese Patent Application Laid-Open No. 2007-34523 discriminate the type of bill of an inputted bill, and reject bills that cannot be discriminated.

### DISCLOSURE OF INVENTION

### Problems to be Solved by the Invention

In cases of using register devices in which the devices recited in Japanese Patent Application Laid-Open No. 2005-293540 and Japanese Patent Application Laid-Open No. 2007-34523 are installed as a bill change machine, when the clerk who carries out the cost computing work such as the register clerk or the like at the register checkout of a store (hereinafter called “store clerk”) cannot discriminate, at the bill change machine, the type of a bill that is received from a customer, there are cases in which the store clerk confirms that bill visually, and the work of accepting bills that are recognized as being authentic bills is carried out. Therefore, when a conventional bill change machine is used, if there is a bill that is a sophisticated fake such that the store clerk cannot visually discriminate whether or not it is an authentic bill (hereinafter called “fake bill”), a loss arises at the store.

Therefore, a bill processing device that can discriminate whether or not an inputted bill is a fake bill is desired.

### Means For Solving the Problems

In accordance with a first aspect of the present invention, there is provided a bill processing device having: (1) a fake bill profile information acquiring unit that acquires, from an external distribution device, fake bill profile information that is used in discriminating fake bills; (2) a fake bill profile information registration unit that registers fake bill profile information that the fake bill profile information acquiring unit acquired; (3) a bill discriminating unit that, on the basis of at least information that is registered in the fake bill profile information registration unit, discriminates at least whether or not a deposited bill that is deposited from a user is a fake bill; and (4) a fake bill processing unit that does not accept a deposited bill that has been discriminated to be a fake bill by the bill discriminating unit.

In accordance with a second aspect of the present invention, there is provided a register device in which the bill processing device of the above-described first aspect is installed.

In accordance with a third aspect of the present invention, there is provided a change machine that (1) is provided with a bill processing device and a coin processing device and is installed in a register device, and (2) applies the bill processing device of the above-described first aspect.

In accordance with a fourth aspect of the present invention, there is provided a distribution device having: (1) a fake bill profile information holding unit that holds fake bill profile information that is used in discriminating fake bills at a bill processing device; and (2) a profile information distribution unit that distributes, to a bill processing device, fake bill profile information that the fake bill profile information holding unit holds.

In accordance with a fifth aspect of the present invention, there is provided a network system having: the register device of the above-described second aspect; and the distribution device of the above-described fourth aspect.

### Effects of the Invention

In accordance with the present invention, there can be provided a bill processing device that discriminates whether or not an inputted bill is a fake bill.

### BRIEF DESCRIPTION OF DRAWINGS

FIG. 1 is a block diagram showing the functional structures of the interior of a bill change machine relating to an embodiment.

FIG. 2 is a block diagram showing the overall structure of a network system relating to the embodiment.

FIG. 3 is a block diagram showing the functional structures of the interior of a register device relating to the embodiment.

FIG. 4 is a perspective view showing the external appearance of the register device relating to the embodiment.

FIG. 5 is a structural drawing of an overview of a side cross-section of the bill change machine relating to the embodiment.

FIG. 6 is a flowchart showing operation of the bill change machine relating to the embodiment.

FIG. 7 is a sequence diagram showing the operation of distributing fake bill profile information in the network system relating to the embodiment.

### BEST MODE FOR CARRYING OUT THE INVENTION

### (A) Embodiment

An embodiment of a bill processing device, a register device, a change machine, a distribution device and a network system in accordance with the present invention is described in detail hereinafter with reference to the drawings. Note that the bill processing device of this embodiment is a bill change machine.

### (A-1) Structure of Embodiment

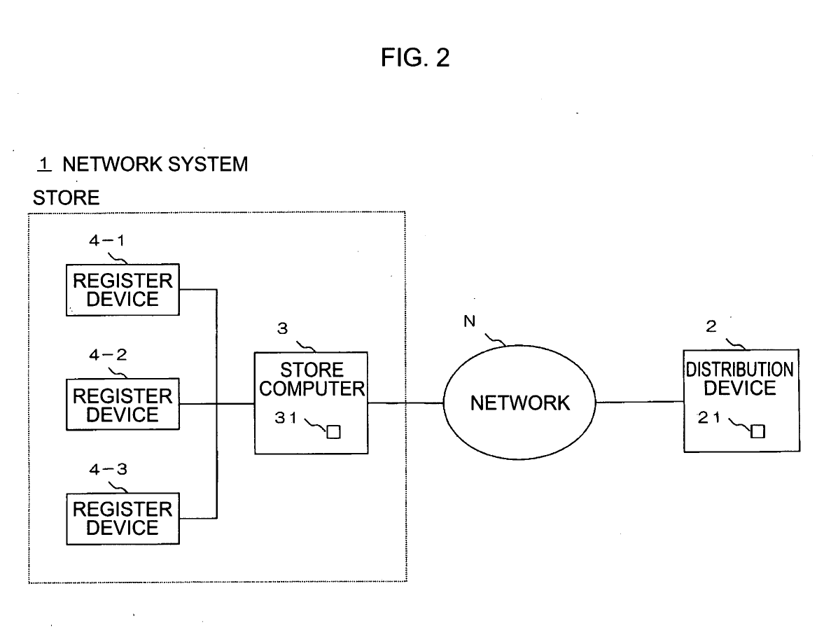

FIG. 2 is a block diagram showing the overall structure of a network system 1 of this embodiment. First, a summary of the overall network system 1 is described, and thereafter, the details of the respective structural elements of the network system 1 are described.

First, a summary of the overall network system 1 is described. The network system 1 has a distribution device 2, a store (shop) computer 3, and three register devices 4 (4-1 to 4-3). Note that, if the network system 1 is a POS system for example, the network system 1 is a system that also has other structures that are needed for a POS system, such as a server that carries out inventory management and the like (not shown).

The register device 4 is a device at which, for example, a store clerk is made to input information such as the amounts of money of the goods or services that a customer purchases, or the like, and inputs the amount of the money that is received from the customer, and totals the sales amount, and accommodates the money received from customers, and the like. If the network system 1 is a POS system for example, a device that functions as a POS register device is applicable as the register device 4.

The place where the register device 4 is set is not limited provided that it is a place where goods or services are sold, such as, for example, a store such as a convenience store, a supermarket, a discount shop, a department store or the like, an eatery such as a restaurant, a cafe or the like, a gas station, or the like.

After the money that is handed-over from the customer to the clerk is inputted, the register device 4 discriminates to which of an authentic bill, a fake bill, or a bill that cannot be discriminated as an authentic bill or a fake bill (hereinafter called an “undiscriminatable bill”), the bill among the inputted money corresponds. Then, the register device 4 accommodates authentic bills therein as is, and rejects fake bills and undiscriminatable bills without accommodating them. Further, when the register device 4 rejects an inputted bill, the register device 4 informs the store clerk to which of a fake bill and an undiscriminatable it corresponds. Then, after a bill is rejected by the register device 4, for example, that bill is returned to the customer, or is exchanged with another bill and inputted, or the like by the store clerk.

Moreover, the register device 4 takes-in and registers, from the distribution device 2 that is described below and via the store computer 3, information that is used in discriminating fake bills (hereinafter called “fake bill profile information”), and, on the basis of the registered fake bill profile information, discriminates whether or not an inputted bill is a fake bill. For example, if there is a fake bill that is a US dollar bill, there are types such as so-called “super K” and “super Z” and the like, and they have different characteristics per type. At the network system 1, fake bill profile information that is defined per type of fake bill is distributed from the distribution device 2 to the register devices 4 on the network system 1, and, at the register device 4, it is discriminated whether or not a bill is a fake bill in accordance with the distributed fake bill profile information.

The store computer 3 is a computer that accommodates the register devices 4-1 to 4-3 at each store, and carries out, for example, management control of the respective register devices 4-1 to 4-3, sales of the entire store, cash management, merchandise inventory management, and the like. Further, the store computer 3 takes-in and stores fake bill profile information from the distribution device 2, and distributes the stored fake bill profile information to the accommodated register devices 4-1 to 4-3.

The store computer 3 is structured by, for example, installing a profile information distribution relay program or the like on an information processing device such as a personal computer or the like (that is not limited to a single device, and may be such that plural devices can carry out distributed processing), and can be expressed functionally as in FIG. 2. The store computer 3 has a profile registration section 31, and fake bill profile information that is distributed from the distribution device 2 is stored by the profile registration section 31.

The distribution device 2 is a device that distributes fake bill profile information to the register devices 4-1 to 4-3 via the store computer 3. The distribution device 2 is structured by, for example, installing a profile information distribution program or the like on an information processing device such as a personal computer or the like (that is not limited to a single device, and may be such that plural devices can carry out distributed processing), and can be expressed functionally as in FIG. 2. The distribution device 2 has a profile registration section 21, and fake bill profile information that is distributed to the store computer 3 is registered by the profile registration section 21. At the distribution device 2, the registering of the fake bill profile information into the profile registration section 21 may be, for example, taking-in from a recording medium or taking-in by downloading from an external device, and the method of registration thereof is not limited.

Details of the structure of the register device 4 are described next.

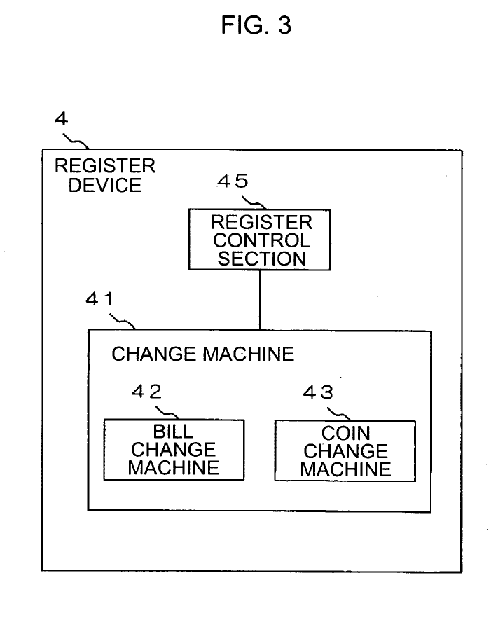

FIG. 3 is a block diagram showing the functional structures of the interior of the register device 4.

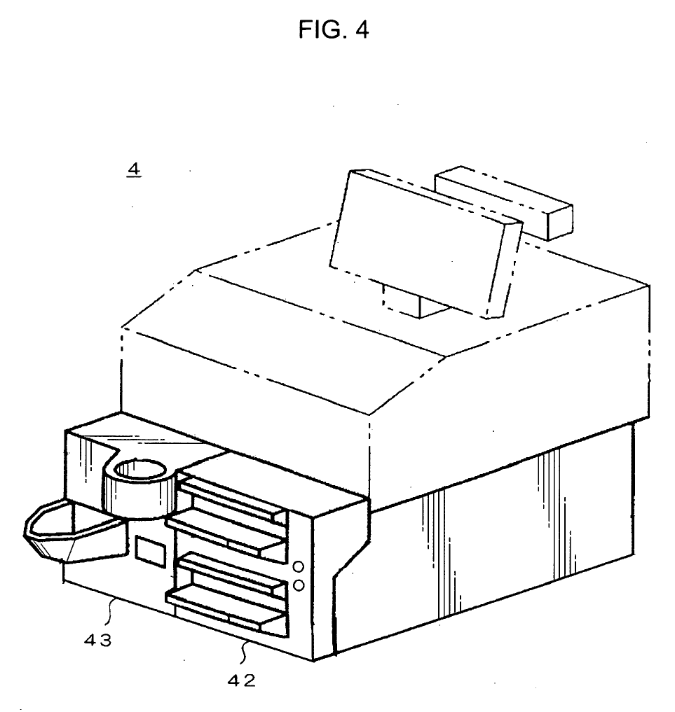

FIG. 4 is a perspective view showing an example of the external appearance of the register device 4.

The register device 4 has a change machine 41 and a register control section 45. Note that, in FIG. 3, the register device 4 is a device that also has other structures (not shown) that are needed for a register device such as, for example, a display device, a receipt printing section, input keys, a barcode reader, and the like. Further, the change machine 41 has a bill change machine 42 and a coin change machine (coin processing device) 43.

The register control section 45 is a section that controls the overall register device 4.

The coin change machine 43 is a machine in which, for example, the store clerk inputs and accommodates coins that are received as money from customers, and further, disburses coins that are to be paid as change to the customer in accordance with control of the register control section 45. A coin change machine (coin processing device) that is installed in an existing register device can be applied.

The bill change machine 42 is a machine in which, for example, the store clerk inputs and accommodates bills that are received as money from customers, and further, disburses bills that are to be paid as change to the customer in accordance with control of the register control section 45.

Details of the structure of the bill change machine 42 are described next.

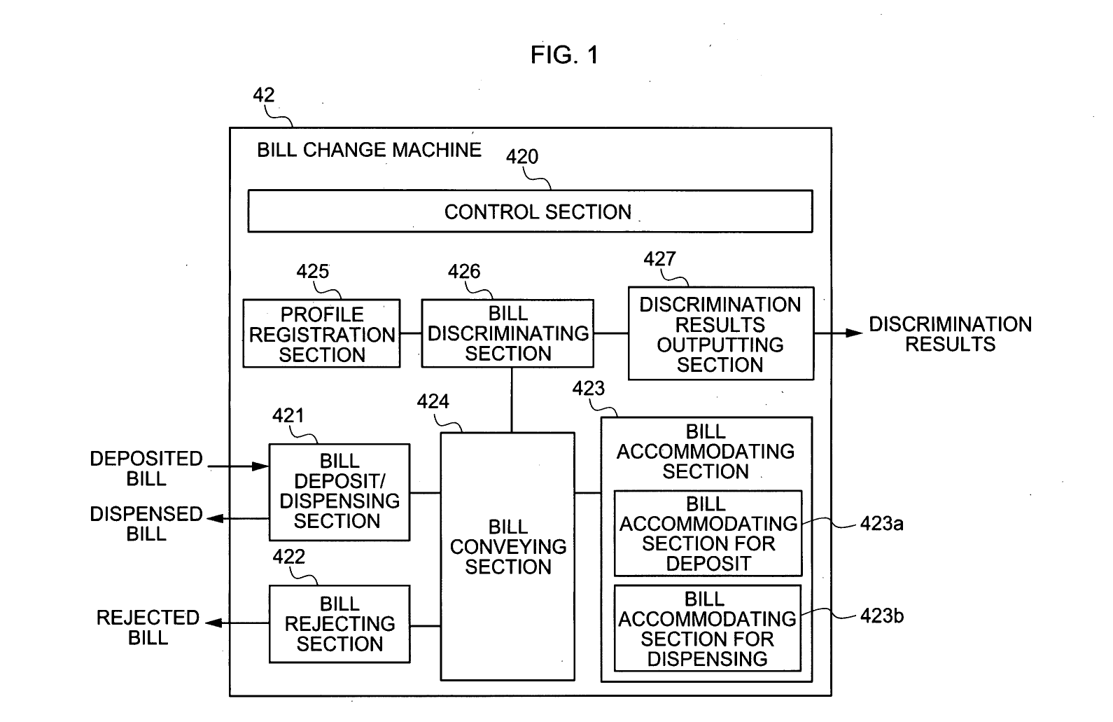

FIG. 1 is a block diagram showing the functional structures of the interior of the bill change machine 42.

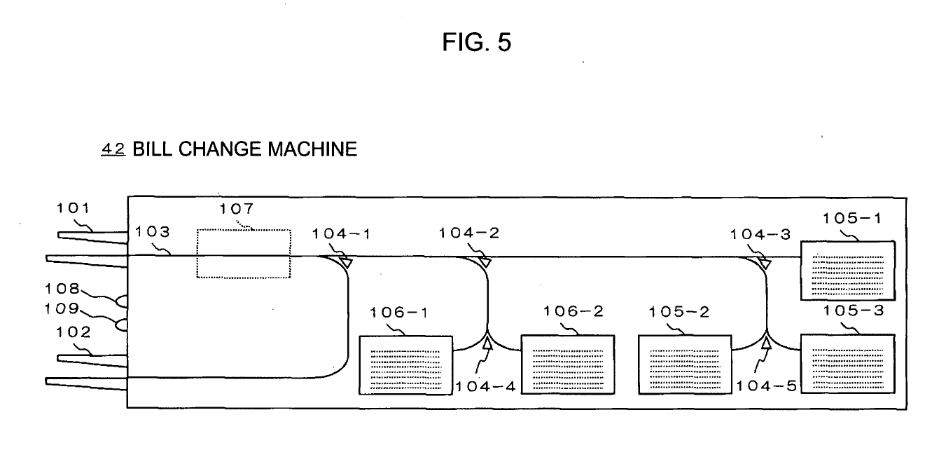

FIG. 5 is an explanatory drawing that shows an overview of a side cross-section of the bill change machine 42.

The bill change machine 42 has a control section 420, a bill deposit/dispensing section 421, a bill rejecting section 422, a bill accommodating section 423, a bill conveying section 424, a profile registration section 425, a bill discriminating section 426, and a discrimination results outputting section 427. Note that, in the following description, the person (e.g., a store clerk or a customer or the like) who uses the bill change machine 42, such as deposits bills into the bill change machine 42 (bill processing device), accepts bills that are dispensed or rejected from the bill change machine 42 (bill processing device), receives the output of the discrimination results from the discrimination results outputting section 427 that is described below, and the like, is simply called the “user” as well.

Here, the bill change machine 42 has, in addition to hardware sections that bear the functions of, for example, inputting/outputting and accommodating bills and the like, a CPU, a ROM, a RAM and the like for executing information processing relating to the discriminating of bills, registration of profile information, and the like, and programs that the CPU executes (including a bill discriminating program) are installed therein. Illustration of the functional structures of the bill change machine 42, including the aforementioned programs, is as per FIG. 1.

The control section 420 is a section that controls the overall operation of the bill change machine 42. Further, the control section 420 is connected to the register control section 45, and may operate in accordance with control signals provided from the register control section 45.

The bill deposit/dispensing section 421 bears the interface functions of taking-in bills that the store clerk receives as money from customers (hereinafter called “deposited bills”), and disbursing, to the store clerk, the bills that are paid as change to the customer (hereinafter called “dispensed bills”). The bill deposit/dispensing section 421 provides the deposited bills, that have been taken-in from the store clerk, to the bill accommodating section 423 via the bill conveying section 424. Further, after dispensed bills are provided from the bill accommodating section 423 via the bill conveying section 424, the bill deposit/dispensing section 421 disburses them to the store clerk.

The bill conveying section 424 conveys the bills at the bill change machine 42 interior.

The bill accommodating section 423 is a section that accommodates deposited bills and dispensed bills, and has a deposited bill accommodating section 423a and a dispensed bill accommodating section 423b. After a bill that is taken-in by the bill deposit/dispensing section 421 is provided via the bill conveying section 424, the deposited bill accommodating section 423a accommodates that bill. The dispensed bill accommodating section 423b accommodates dispensed bills, provides dispensed bills to the bill deposit/dispensing section 421 via the bill conveying section 424, and disburses them to the store clerk.

After a bill, that is discriminated to be a fake bill or an undiscriminatable bill by the bill discriminating section 426 that is described below, is provided via the bill conveying section 424, the bill rejecting section 422 rejects that bill to the store clerk.

The profile registration section 425 registers fake bill profile information that is distributed from the distribution device 2. At the register device 4, the fake bill profile information provided from the store computer 3 is provided from the register control section 45 to the control section 420, and is registered in the profile registration section 425 by the control section 420.

Further, information that is used in discriminating authentic bills (hereinafter called “authentic bill profile information” is registered in the profile registration section 425 per type of bill that the bill change machine 42 accommodates.

On the basis of the fake bill profile information and the authentic bill profile information that are registered in the profile registration section 425, the bill discriminating section 426 discriminates which of an authentic bill, a fake bill and an undiscriminatable bill, a deposited bill corresponds to. Then, a bill that is discriminated to be an authentic bill by the bill discriminating section 426 is accommodated in the bill accommodating section 423, and a bill that is discriminated to be a fake bill or an undiscriminatable bill is rejected to the store clerk by the bill rejecting section 422 without being accepted. Further, a bill that is discriminated as being a fake bill or an undiscriminatable bill by the bill discriminating section 426 may, for example, be stored in an unillustrated, predetermined storage depository without being accepted. If a bill that is discriminated as being a fake bill or an undiscriminatable bill is stored in the aforementioned, predetermined storage depository without being accepted, the bill change machine 42 may, for example, store fake bills and undiscriminatable bills in separate storage depositories, or may store them in a same storage depository.

The bill discriminating section 426 may carry out discriminating of a bill by, for example, acquiring information relating to a deposited bill (e.g., image data in which the bill is captured or the like) by using a sensor, and searching for authentic bill profile information or fake bill profile information that matches the acquired information. Further, if the bill discriminating section 426 first searches only authentic bill profile information and authentic bill profile information that matches the information relating to the deposited bill is detected, the bill discriminating section 426 may discriminate that the deposited bill is an authentic bill without searching the fake bill profile information, or may discriminate collectively from results of searching both the authentic bill profile information and the fake bill profile information. An existing bill discriminating machine can be applied in the discriminating of fake bills and authentic bills at the bill discriminating section 426. Further, for the contents of the fake bill profile information as well, the format and contents of data that are set at an existing bill discriminating machine can be applied.

The discrimination results outputting section 427 outputs the discrimination results of the bill discriminating section 426. The discrimination results outputting section 427 may, for example, be provided with a lamp that lights in accordance with the discrimination results of the bill discriminating section 426 and output the discrimination results to the store clerk, or may be provided with a speaker and output by sound. Further, if the register device 4 is provided with a display, the discrimination results outputting section 427 may the discrimination results on the display and output them to the store clerk. In this way, the discrimination results outputting section 427 is a section whose method of outputting discrimination results to the store clerk is not limited.

Details of the respective functional structure portions of the bill change machine 42 are supplementarily explained by using FIG. 5.

The bill conveying section 424 may be realized by using, for example, a conveying path 103, switching blades 104-1 to 104-5, and the like as shown in FIG. 5. The conveying path 103 is structured by belts or the like that nip and convey bills. The switching blades 104-1 to 104-5 are disposed at the forking or merging portions on the conveying path 103, and are blades that switch the conveying direction of the bill. In the bill conveying section 424, the direction in which the conveying path 103 conveys the bill and the directions of the respective switching blades 104-1 to 104-5 are controlled in accordance with the conveying destination of the bill. Structures that are used in an existing bill change machine can respectively be applied as the conveying path 103, the switching blades 104-1 to 104-5.

The bill deposit/dispensing section 421 may be realized by, for example, using a bill deposit/dispensing opening 101 as shown in FIG. 5. The bill deposit/dispensing opening 101 bears the functions of a deposit opening that takes-in deposited bills, and a dispensing opening that disburses and accumulates dispensed bills. Deposited bills that are inputted to the bill deposit/dispensing opening 101 are separated one-by-one by using separating rollers or the like, and are drawn-out to the conveying path 103. Further, when dispensed bills are conveyed on the conveying path 103 and reach the bill deposit/dispensing opening 101, the bill deposit/dispensing opening 101 accumulates the dispensed bills that have arrived thereat, and disburses them to the store clerk. A bill deposit/dispensing opening that is used in an existing bill change machine can be applied as the bill deposit/dispensing opening 101.

The bill rejecting section 422 may be realized by, for example, using a bill rejecting opening 102 as shown in FIG. 5. When deposited bills that are discriminated to be fake bills or undiscriminatable bills are conveyed on the conveying path 103 and reach the bill rejecting section 422, the bill rejecting section 422 accumulates these bills, and disburses them to the store clerk. A bill dispensing opening that is used in an existing bill change machine can be applied as the bill rejecting section 422.

At the bill discriminating section 426, for example, as shown in FIG. 5, a sensor 107 may be disposed on the conveying path 103, and information relating to the deposited bill that is carried on the conveying path 103 may be acquired by using this sensor 107. The sensor 107 is, for example, a sensor that acquires data of an image captured by using visible light, infrared light, ultraviolet light, or the like, or detects the size and the paper quality and the like of the bill. A sensor that is used in an existing bill discriminating machine can be applied as the sensor 107.

The deposited bill accommodating section 423a may be realized by, for example, using deposited bill accommodating depositories 105-1 to 105-3 as shown in FIG. 5. The deposited bill accommodating depositories 105-1 to 105-3 are depositories that accommodate deposited bills of respectively different types. Note that, in FIG. 5, the three deposited bill accommodating depositories 105-1 to 105-3 are disposed at the bill change machine 42. However, a number corresponding to the number of types of bills that are accommodated as deposited bills may be disposed at the bill change machine 42, and the number of deposited bill accommodating depositories that are disposed at the bill change machine 42 is not limited. Accommodating depositories of deposited bills that are used at an existing bill change machine can be applied as the deposited bill accommodating depositories 105-1 to 105-3.

The dispensed bill accommodating section 423b may be realized by, for example, using dispensed bill accommodating depositories 106-1, 106-2 as shown in FIG. 5. The dispensed bill accommodating depositories 106-1, 106-2 are depositories that accommodate dispensed bills of respectively different types. Note that, in FIG. 5, the two dispensed bill accommodating depositories 106-1, 106-2 are disposed at the bill change machine 42. However, a number corresponding to the number of types of bills that are accommodated as dispensed bills may be disposed at the bill change machine 42, and the number of dispensed bill accommodating depositories that are disposed at the bill change machine 42 is not limited. The dispensed bill accommodating depositories 106-1, 106-2 may be provided with, for example, an unillustrated stage that moves vertically, and the accommodated bills may be accumulated on the stage, and the accommodated bills may be separated one-by-one by an unillustrated roller mechanism and drawn-out onto the conveying path 103. Accommodating depositories of dispensed bills that are used at an existing bill change machine can be applied as the dispensed bill accommodating depositories 106-1, 106-2.

The discrimination results outputting section 427 may be realized by, for example, using discrimination results displaying lamps 108, 109 as shown in FIG. 5. The discrimination results outputting section 427 may notify the store clerk of the discrimination results by, for example, if there is a bill that is discriminated to be a fake bill at the bill discriminating section 426, lighting the lamp of the discrimination results displaying lamp 108, and, if there is a bill that is discriminated to be an authentic bill, lighting the lamp of the discrimination results displaying lamp 109. Further, the lamps may be lit by varying the colors such that, for example, the lamp of the discrimination results displaying lamp 108 is lit yellow and the lamp of the discrimination results displaying lamp 109 is lit red. Further, in FIG. 5, the discrimination results displaying lamps 108, 109 are drawn so as to be disposed at the front surface of the bill change machine 42. However, the positions and the sizes and the like of the lamps are not limited provided that the store clerk can confirm them.

### (A-2) Operations of the Embodiment

Operations of the bill change machine 42 of this embodiment, that has a structure such as described above, are described next.

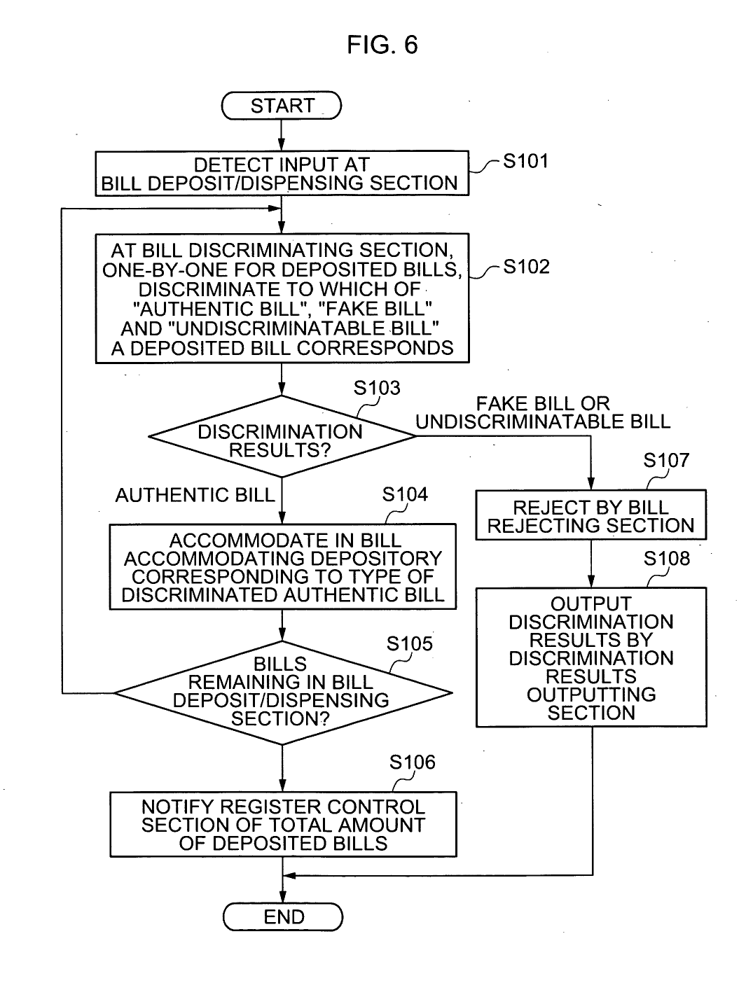

FIG. 6 is a flowchart that explains the operation of depositing at the bill change machine 42.

First, when deposited bills are inputted to the bill deposit/dispensing section 421 by the store clerk, the inputting of deposited bills is detected at the bill deposit/dispensing section 421 (S101).

When the inputting of deposited bills has been detected at the bill deposit/dispensing section 421, the inputted deposited bills are conveyed one-by-one to the bill discriminating section 426 by the bill conveying section 424, and it is discriminated, by the bill discriminating section 426, to which of an “authentic bill”, a “fake bill” and an “undiscriminatable bill” the deposited bill corresponds (S102).

A deposited bill that is discriminated as a “fake bill” or an “undiscriminatable bill” in above-described step S102 is conveyed by the bill conveying section 424 to the bill rejecting section 422, and is rejected to the store clerk, and an “undiscriminatable bill” is returned to the customer (S103, S107). Note that bills that are judged to be “fake bills” can be returned to the customer, but they may be stored in an unillustrated predetermined storage depository. Then, the discrimination results in above-described step S102 are outputted (S108) to the store clerk by lamp display or the like, and processing ends. Note that, if a bill is discriminated to be a “fake bill” or an “undiscriminatable bill” in above-described step S102, a bill of the same value as an authentic bill accommodated in the bill accommodating section 423 up until then may be disbursed to the bill deposit/dispensing section 421.

On the other hand, a deposited bill that is discriminated as an “authentic bill” in above-described step S102 is conveyed by the bill conveying section 424 to the bill accommodating section 423 (the deposited bill accommodated section 423a), and is accommodated in the deposited bill accommodating depository that corresponds to the type of that bill (S103, S104).

Then, it is judged whether or not a deposited bill remains in the bill deposit/dispensing section 421 (S015), and if a deposited bill remains, the bill change machine 42 operates again from above-described step S102, and discrimination by the bill discriminating section 426 is carried out for all of the deposited bills that have been inputted to the bill deposit/dispensing section 421.

On the other hand, if it is judged that a deposited bill does not remain in the bill deposit/dispensing section 421 in above-described step S104, the total amount of the deposited bills that have been discriminated as authentic bills by the bill discriminating section 426 up until then is notified to the register device 4 (the register control section 45), and processing ends (S106). Note that the total amount of the deposited bills may be, for example, inputted manually (e.g., by key operation at the register device 4 or the like) by the store clerk, without being computed by the bill change machine 42.

Operation of distributing the distribution device fake bill profile information is described next.

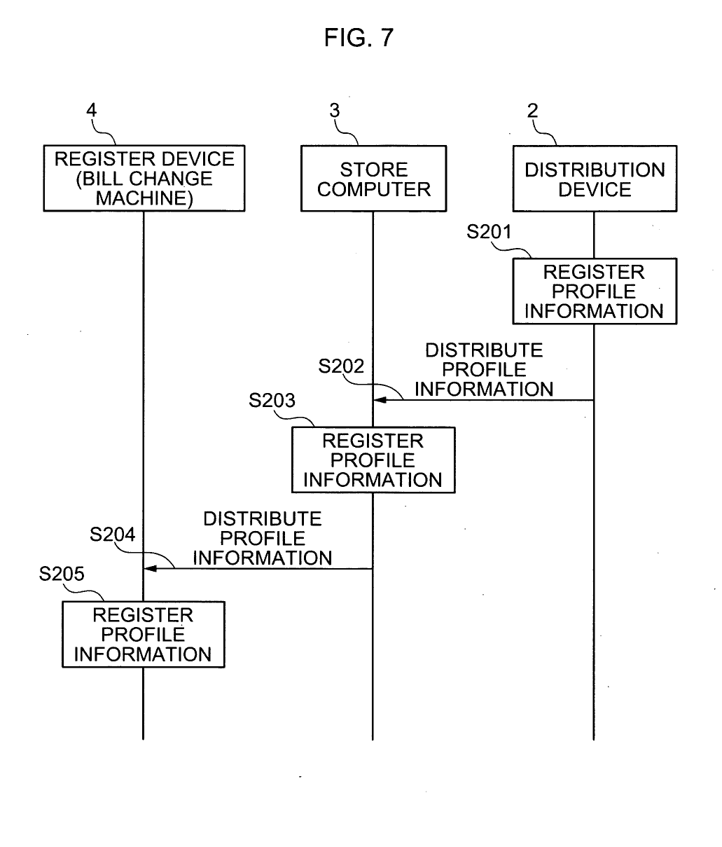

FIG. 7 is a sequence diagram that explains the operation of fake bill profile information being distributed from the distribution device 2 to the register device 4 (bill change machine 42).

First, at the distribution device 2, fake bill profile information is newly registered in the profile registration section 21 (S201).

Then, the fake bill profile information registered in the profile registration section 21 is distributed from the distribution device 2 to the store computer 3 (S202), and is registered in the profile registration section 31 (S203). The distributed fake bill profile information of the fake bill profile information from the distribution device 2 to the store computer 3 in above-described step S202 may be only a portion, such as the difference between the information registered in the distribution device 2 (the profile registration section 21) and the information registered in the store computer (the profile registration section 31), or the like, or all of the information that is registered in the distribution device 2 (the profile registration section 21) may be transmitted. Further, in the distribution of the fake bill profile information from the distribution device 2 to the store computer 3 in above-described step S202, information may be distributed to all of the store computers 3 at the point in time when information is newly registered in the distribution device 2, or information may be distributed to the request sources at points in time corresponding to the requests of the respective store computers 3, or information may be distributed to the store computer 3 that is newly started-up, or the distribution device 2 may distribute information periodically.

Then, the fake bill profile information that is registered in the profile registration section 31 is distributed from the store computer 3 to the bill change machines 42-1 to 42-3 of the respective register devices 4-1 to 4-3 (S204), and, at the bill change machines 42-1 to 42-3, this fake bill profile information is registered in the profile registration sections 425 (S205). The distributed fake bill profile information of the fake bill profile information from the store computer 3 to the bill change machines 42-1 to 42-3 in above-described step S204 may be merely a portion, such as the difference between the information registered in the store computer 3 and the information registered in the respective bill change machines 42-1 to 42-3, or the like, or all of the information that is registered in the store computer 3 may be distributed. Further, in the distribution of the fake bill profile information from the store computer 3 to the respective bill change machines 42-1 to 42-3 in above-described step S205, information may be distributed to all of the register devices 4-1 to 4-3 at the point in time when information is newly registered in the store computer 3, or information may be distributed to the request sources at points in time corresponding to the requests of the respective register devices 4-1 to 4-3, or information may be distributed to the register devices 4-1 to 4-3 that are newly started-up, or the store computer 3 may distribute information periodically.

### (A-3) Effects of the Embodiment

Effects such as the following can be achieved in accordance with this embodiment.

In a conventional register device, it has been only discriminated which of an “authentic bill” and an “undiscriminatable bill” an deposited bill is. In the register device 4, in addition to “authentic bill” and “undiscriminatable bill”, it can also be discriminated whether or not a deposited bill is a “fake bill”. Due thereto, sophisticated fake bills that a store clerk cannot visually discriminate also are discriminated as fake bills, and the store clerk can return the fake bills to the customer, and therefore, losses of the store can be reduced.

Further, due to it being possible to also discriminate, as fake bills, sophisticated fake bills that a store clerk cannot visually discriminate, even high-denomination bills (e.g., 50 dollar bills and 100 dollar bills in the US), with respect to which the existence of fake bills has been of concern and that a store clerk could not accept from a customer conventionally, can be accepted without worry from customers, and therefore, the convenience for customers at a store can be improved.

Moreover, at the network system 1, as shown in above-described FIG. 7, because the fake bill profile information that is registered in the distribution device 2 is distributed to the register devices 4, at the register device 4, it can be discriminated, on the basis of the latest fake bill profile information, whether or not an inputted bill is a fake bill. Because the types of fake bills are increasing every day, the accuracy of discriminating fake bills can be improved by the register device 4 carrying out discrimination of an inputted bill on the basis of the latest fake bill profile information.

Still further, at the network system 1, fake bill profile information is distributed from the distribution device 2 via the network to the store computer 3 and the register devices 4 thereunder. Therefore, even if numerous registered devices 4 are disposed, the fake bill profile information can be distributed quickly and easily.

### (B) Other Embodiments

The present invention is not limited to the above-described embodiment, and modified embodiments such as exemplified below can also be given as examples.

(B-1) In the above-described embodiment, if a fake bill is detected, the bill change machine 42 outputs the discrimination results to the store clerk by lamp display or the like by the discrimination results outputting section 427. However, notification may be given to another party, e.g., the police, the manager of the store, the person in charge of security at the store or the like, and not only to the store clerk. As a method of notifying a party other than the store clerk of the discrimination results, for example, notification may be given to an external device by using email (messaging) or by sound or the like via the network N or another communication line or the like, and the method of notifying is not limited. Due thereto, the store clerk can rapidly let other parties know of the occurrence of a fake bill.

(B-2) In the above-described embodiment, what is distributed from the distribution device 2 to the register devices 4 (the bill change machines 42) is only the fake bill profile information. However, other information also may be distributed.

For example, authentic bill profile information also may be distributed from the distribution device 2 to the register devices 4. Due thereto, for example, also if new types of bills are introduced, an environment that carries out discrimination of the new bills can be constructed easily at the bill change machine 42. Further, for example, also if authentic bill profile information of a higher recognition accuracy is generated, it can be applied immediately.

Further, for example, the identification numbers of specific bills may be distributed from the distribution device 2 to the register devices 4. Then, at the register device 4 side, for a deposited bill, the identification number of the bill may be read-in by an existing OCR (Optical Character Reader) or the like, and it may be judged whether or not it matches an identification number distributed from the distribution device 2, and if it is judged that they match, that bill may be rejected and the judgment results may be outputted in the same way as discrimination results. Due thereto, for example, bills that are authentic bills but are ill-gotten, such as bills that have been stolen in a bank robbery or the like, or the like, are detected as the aforementioned specific bills, and use of ill-gotten bills can be prevented.

(B-3) In the above-described embodiment, at the bill change machine 42, the bill discriminating section 426 is one structure. However, plural bill discriminating sections may be disposed. For example, one may be disposed as a section that discriminates whether or not a deposited bill is an authentic bill, and another one may be disposed as a section that discriminates whether or not a deposited bill is a fake bill. Due thereto, while one bill discriminating section is discriminating whether or not a deposited bill is an authentic bill, the other bill discriminating section can discriminate whether or not another bill is a fake bill. Namely, because the bill change machine 42 can simultaneously discriminate plural bills in the manner of a pipeline, the discriminating speed can be improved.

(B-4) In the above-described embodiment, at the bill accommodating section 423, separate bill accommodating depositories are provided at the deposited bill accommodating section 423a and the dispensed bill accommodating section 423b (see FIG. 1, FIG. 5). However, a bill accommodating depository may be used in common for the same type of bills, and deposited bills may be recycled and dispensed as change to be handed-over to customers. For example, in FIG. 5, at the bill change machine 42, the three deposited bill accommodating depositories 105-1 to 105-3 and the two dispensed bill accommodating depositories 106-1, 106-2 are provided. However, these bill accommodating depositories may be replaced by three deposited/dispensed bill accommodating depositories. For example, a bill accommodating depository, that is installed in a structure that recycles and dispenses deposited bills at an existing bill change machine, can be applied as the deposited/dispensed bill accommodating depository.

(B-5) In the above-described embodiment, the distribution device 2 distributes information to the register devices 4 (the bill change machines 42) via the store computer 3. However, the distribution device 2 may distribute information directly to the register devices 4 (the bill change machines 42).

(B-6) In the above-described embodiment, at the bill deposit/dispensing section 421, the depositing and dispensing of bills is realized by using the one bill deposit/dispensing opening 101. However, separate openings may be disposed for depositing and dispensing respectively, or bills may be dispensed at the opening that is common to the bill rejecting section 422, i.e., the bill rejecting opening 102.

(B-7) In the above-described embodiment, the bill change machine 42 and the coin change machine 43 are installed in the change machine 41 of the register device 4. However, there may be a structure in which only the bill change machine 42 is installed in the change machine 41 of the register device 4.

(B-8) In the above-described embodiment, the discriminating of bills is carried out only with respect to deposited bills at the bill discriminating section 426. However, discriminating of bills may similarly be carried out with respect to dispensed bills as well. Then, if a dispensed bill is discriminated as a fake bill or an undiscriminatable bill at the bill discriminating section 426, in the same way as in the case of a deposited bill, that dispensed bill may be rejected to the store clerk by the bill rejecting section 422, and the discrimination results may be outputted by the discrimination results outputting section 427. Due thereto, also if bills that have not been discriminated at the bill discriminating section 426 are accommodated in the bill accommodating section 423, the store clerk can be prevented from handing-over a fake bill to a customer as change.

Further, after a deposited bill that has been discriminated as being an authentic bill is accommodated, when new fake bill profile information is distributed, also in cases in which deposited bills are recycled, only the bills for which discrimination has been carried out on the basis of the latest fake bill profile information can be dispensed.

(B-9) In the above-described embodiment, the bill change machine 42 discriminates, by the bill discriminating section 426, to which of an authentic bill, a fake bill and an undiscriminatable bill a deposited bill corresponds. However, it is possible to discriminate only whether or not a deposited bill is a fake bill.

For example, at the bill change machine 42, if new fake bill profile information is distributed or the like, for all of the bills that are accommodated in the bill accommodating section 423, it can be discriminated whether or not a bill is a fake bill on the basis of the new fake bill profile information, and, by accommodating again only the bills that are discriminated as not being fake bills, it is possible to always accommodate only bills that have been discriminated on the basis of the latest fake bill profile information. At this time, the store clerk may be made to manually take-out and input bills from the bill accommodating section 423, or, a bill accommodating depository for withdrawal that once withdraws bills that are accommodated in the bill accommodating section 423 may be provided separately, and bills may automatically be withdrawn to this bill accommodating depository for withdrawal and the withdrawn bills may be deposited.

(B-10) In the above-described embodiment, the bill processing device is described as a bill change machine that is applied to a register device. However, the bill processing device of the above-described embodiment may be applied to the processing of bills at an ATM (Automated Teller Machine) that is set at a bank or the like, or an automatic money exchange device, or an automatic vending machine, or the like, and the object of application is not limited.

1. A bill processing device comprising:
a fake bill profile information acquiring unit that acquires, from an external distribution device, fake bill profile information that is used in discriminating fake bills;
a fake bill profile information registration unit that registers the fake bill profile information that the fake bill profile information acquiring unit acquired;
a bill discriminating unit that, on the basis of at least information that is registered in the fake bill profile information registration unit, discriminates at least whether or not a deposited bill that is deposited from a user is a fake bill; and
a fake bill processing unit that does not accept a deposited bill that has been discriminated to be a fake bill by the bill discriminating unit.

2. The bill processing device of claim 1, further comprising:
an authentic bill profile information registration unit that registers authentic bill profile information that is used in discriminating authentic bills; and
a deposited bill accommodating unit that accommodates deposited bills that have been discriminated to be authentic bills,
wherein, on the basis of at least information that is registered in the authentic bill profile information registration unit, the bill discriminating unit further discriminates whether or not the deposited bill is an authentic bill, and
the deposited bill accommodating unit accommodates deposited bills that have been discriminated to be authentic bills by the bill discriminating unit.

3. The bill processing device of claim 2, further comprising:
an undiscriminatable bill processing unit that does not accept a deposited bill that has been discriminated to be an undiscriminatable bill,
wherein the bill discriminating unit discriminates a deposited bill, that cannot be discriminated to be an authentic bill or a fake bill, to be an undiscriminatable bill, and
the undiscriminatable bill processing unit does not accept a deposited bill that has been discriminated to be an undiscriminatable bill by the bill discriminating unit.

4. The bill processing device of claim 2, further comprising an authentic bill profile information acquiring unit that acquires authentic bill profile information from the distribution device,
wherein the authentic bill profile information registration unit registers authentic bill profile information that the authentic bill profile information acquiring unit acquired.

5. The bill processing device of claim 1, further comprising a discrimination results outputting unit that outputs discrimination results provided by the bill discriminating unit.

6. The bill processing device of claim 1 that is installed in a register device.

7. A register device in which is installed a bill processing device that comprises:
a fake bill profile information acquiring unit that acquires, from an external distribution device, fake bill profile information that is used in discriminating fake bills;
a fake bill profile information registration unit that registers the fake bill profile information that the fake bill profile information acquiring unit acquired;
a bill discriminating unit that, on the basis of at least information that is registered in the fake bill profile information registration unit, discriminates at least whether or not a deposited bill that is deposited from a user is a fake bill; and
a fake bill processing unit that does not accept a deposited bill that has been discriminated to be a fake bill by the bill discriminating unit.

8. A change machine that is installed in a register device, the change machine comprising:
a bill processing device comprising:
a fake bill profile information acquiring unit that acquires, from an external distribution device, fake bill profile information that is used in discriminating fake bills,
a fake bill profile information registration unit that registers the fake bill profile information that the fake bill profile information acquiring unit acquired,
a bill discriminating unit that, on the basis of at least information that is registered in the fake bill profile information registration unit, discriminates at least whether or not a deposited bill that is deposited from a user is a fake bill, and
a fake bill processing unit that does not accept a deposited bill that has been discriminated to be a fake bill by the bill discriminating unit; and
a coin processing device.

9. A distribution device comprising:
a fake bill profile information holding unit that holds fake bill profile information that is used in discriminating fake bills at a bill processing device; and
a profile information distribution unit that distributes, to the bill processing device, the fake bill profile information that the fake bill profile information holding unit holds.

10. A network system comprising:
a register device in which is installed a bill processing device that comprises:
a fake bill profile information acquiring unit that acquires, from an external distribution device, fake bill profile information that is used in discriminating fake bills,
a fake bill profile information registration unit that registers the fake bill profile information that the fake bill profile information acquiring unit acquired,
a bill discriminating unit that, on the basis of at least information that is registered in the fake bill profile information registration unit, discriminates at least whether or not a deposited bill that is deposited from a user is a fake bill, and
a fake bill processing unit that does not accept a deposited bill that has been discriminated to be a fake bill by the bill discriminating unit; and
a distribution device comprising:
a fake bill profile information holding unit that holds the fake bill profile information that is used in discriminating fake bills at the bill processing device, and
a profile information distribution unit that distributes, to the bill processing device, the fake bill profile information that the fake bill profile information holding unit holds.
